(19) United States
(12) Patent Application Publication
(10) Pub. No.: US 2026/0260397 A1
(43) Pub. Date: Sep. 3, 2026

(54) DATA ACQUISITION METHOD AND APPARATUS, DEVICE, AND SYSTEM

(71) Applicant: Shanghai Cambricon Information Technology Co., Ltd., Shanghai (CN)

(72) Inventors: Yancheng LAN, Shanghai (CN); Jinsong LIU, Shanghai (CN); Kang YANG, Shanghai (CN); Yangyang YE, Shanghai (CN)

(21) Appl. No.: 18/846,635

(22) PCT Filed: Mar. 2, 2023
(86) PCT No.: PCT/CN2023/079307

§ 371 Date: Sep. 12, 2024

(30) Foreign Application Priority Data
Mar. 18, 2022 (CN) 202210274652.9

(51) Int. Cl. G06T 11/10; G06T 3/02; G06T 7/11; G06T 7/73

(52) U.S. Cl. CPC G06T 11/10; G06T 3/02; G06T 7/11; G06T 7/73; G06T 2207/20132; G06T 2207/30208

(57) ABSTRACT

The embodiments of present disclosure provide a data acquisition method, apparatus, device, and system. The data acquisition device includes a processor and a memory. The processor is connected with the memory, where the memory is configured to store program codes, and the processor is configured to call the program codes. This solution greatly reduces the cost of data collection and provides data support for a new perception network architecture that ISP can learn. In addition, this solution can significantly reduce algorithm iteration time, avoid heavy annotation work, and quickly iterate algorithm versions.

### TECHNICAL FIELD

This application claims priority to the Chinese patent application filed to the China National Intellectual Property Administration on Mar. 18, 2022, with application number 202210274652.9 and application name “Data Acquisition Method, Apparatus, Device and System”, all contents of which are incorporated by reference in this application.

The present disclosure relates to the field of wireless communication technology, and in particular to a data acquisition method, apparatus, device, and system.

### BACKGROUND

The intelligent perception technology in the visual AI algorithm uses RGB (red, green and blue) images that are perceived well by human eyes as training data. These data are not directly obtained by various camera sensors, but have been processed by an image signal processing (ISP) unit. The purpose of a traditional ISP is to obtain images that conform to people's subjective feelings, but there is a difference between this and machine vision perception.

In recent years, the academic community has proposed a perception architecture that transforms a traditional ISP unit into a learnable form, combines it with upper-level perception algorithms, and starts from raw data directly output by the sensor. However, this new form of perception architecture requires annotated raw data as training data. Data sets are mostly acquired by collecting data in the real world using cameras and then manually cleaned and annotated. This method is extremely costly and inefficient.

### SUMMARY

The embodiments of the present disclosure provide a data acquisition method, apparatus, device, and system, which may not only acquire data at low cost and high efficiency, but also ensure the validity of the data.

In a first aspect, an embodiment of the present disclosure provides a data acquisition method, including:
photographing an annotated target image to obtain a first image;
redirecting the first image to obtain a second image, where a coordinate system of the second image is consistent with a coordinate system of the target image; and
performing style transfer on the second image according to a third image to obtain an annotated raw image, where the third image is obtained by photographing a real environment corresponding to the target image.

In the embodiment of the present disclosure, by photographing the annotated target image, redirecting the annotated target image, and performing style transfer on the obtained image using the raw image collected in the real environment as supervision, the authenticity of the collected training data may be ensured to the greatest extent, the difference between the annotated raw image obtained and the raw image collected in the real environment may be reduced, data collection cost may be greatly reduced, and data support may be provided for a new perception network architecture that can be learned by the ISP. In addition, this solution can significantly reduce algorithm iteration time, avoid heavy annotation work, and quickly iterate algorithm versions.

In a second aspect, an embodiment of the present disclosure provides a data acquisition apparatus, including:
a shooting unit configured to photograph an annotated target image to obtain a first image;
a processing unit configured to redirect the first image to obtain a second image, where a coordinate system of the second image is consistent with a coordinate system of the target image; and
a transferring unit configured to perform style transfer on the second image according to a third image to obtain an annotated raw image, where the third image is obtained by photographing a real environment corresponding to the target image.

In a third aspect, an embodiment of the present disclosure provides a data acquisition device including a processor and a memory. The processor is connected with the memory, where the memory is configured to store program codes, and the processor is configured to call the program codes to execute the data acquisition method as described in any implementation of the first aspect.

In a fourth aspect, an embodiment of the present disclosure provides a computer-readable storage medium. The computer-readable storage medium is stored with a computer program, where the computer program includes a program instruction, and when the program instruction is executed by a processor, the data acquisition method as described in any implementation of the first aspect is implemented.

In a fifth aspect, an embodiment of the present disclosure provides a computer program product, including a computer program, which, when executed by a processor, implements the data acquisition method as described in any implementation of the first aspect.

In the sixth aspect, an embodiment of the present disclosure provides a chip system, which is applied to an electronic device. The chip system includes one or more interface circuits and one or more processors, and the interface circuit and the processor are interconnected through lines. The interface circuit is configured to receive a signal from a memory of the electronic device and send the signal to the processor, where the signal includes a computer instruction stored in the memory. When the processor executes the computer instruction, the electronic device executes the data acquisition method as described in any implementation of the first aspect.

### BRIEF DESCRIPTION OF DRAWINGS

In order to illustrate the technical solutions in the embodiments of the present disclosure more clearly, the drawings to be used in the description of the embodiments are briefly explained below. Obviously, the drawings in the description below are some embodiments of the present disclosure. Other drawings can be obtained according to the disclosed drawings without any creative effort by those skilled in the art.

FIG. 1 is a flow diagram of a data acquisition method according to an embodiment of the present disclosure;

FIG. 2 is a flow diagram of another data acquisition method according to an embodiment of the present disclosure;

FIG. 3 is a diagram of style transfer processing according to an embodiment of the present disclosure;

FIG. 4 is an application diagram of a data acquisition method according to an embodiment of the present disclosure;

FIG. 5 is a structural diagram of a data acquisition apparatus according to an embodiment of the present disclosure;

FIG. 6 is a structural diagram of a data acquisition device according to an embodiment of the present disclosure.

### DETAILED DESCRIPTION

Technical solutions in embodiments of the present disclosure will be described clearly and completely hereinafter with reference to the accompanied drawings in the examples of the present disclosure.

It should be understood that the terms “first”, “second”, and the like in the description and claims of the present disclosure and the above-mentioned drawings are used for distinguishing different objects rather than describing a specific order. In addition, terms such as “include”, “have”, and any variant thereof are used for indicating non-exclusive inclusion. For instance, a process, a method, a system, a product, or an equipment including a series of steps or units is not limited to the listed steps or units, but optionally includes steps or units that are not listed, or optionally includes other steps or units inherent to the process, the method, the product, or the equipment.

Reference to “example” in the present disclosure means that a particular feature, a structure, or a characteristic described in conjunction with the embodiment may be included in at least one embodiment of the present disclosure. The use of the term in various places in the specification does not necessarily refer to the same embodiment, nor is it referring independent or alternative embodiments that are mutually exclusive with other embodiments. It is explicitly and implicitly understood by those skilled in the art that the embodiments described in the specification may be combined with other embodiments.

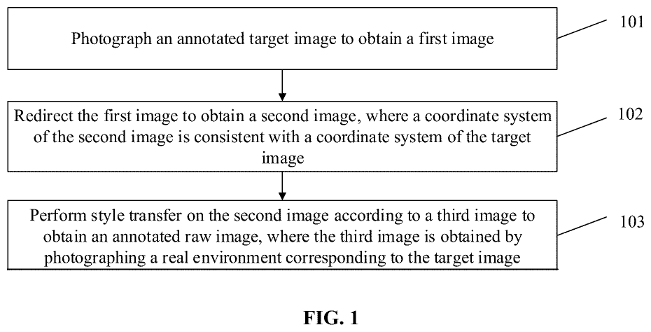

FIG. 1 is a flow diagram of a data acquisition method according to an embodiment of the present disclosure. As shown in FIG. 1, the method includes steps 101-103, which are specifically as follows.

In step 101, an annotated target image is photographed to obtain a first image.

The target image may be displayed on a display screen, or may be a photo of the target image, or may be a printed display of the target image, etc. This solution does not make any specific limitation on this.

The target image can be one or more, and this solution does not make any specific limitation on this. For example, the target image may be a small number of images collected by photographing a real world.

The annotated target image may be, for example, an annotated RGB image.

Specifically, an existing annotated RGB data set (target image) is played on a display screen, and a target camera or the like is configured to photograph the display screen to obtain corresponding raw data. An image captured by the camera is the first image mentioned above.

In step 102, the first image is redirected to obtain a second image, where a coordinate system of the second image is consistent with a coordinate system of the target image.

Since the coordinate systems of the first image and the target image are not necessarily the same, the first image is redirected, so that its coordinate system is consistent with the coordinate system of the target image.

For example, redirection can be achieved through coordinate transformation and other means.

In step 103, style transfer is performed on the second image according to a third image to obtain an annotated raw image, where the third image is obtained by photographing a real environment corresponding to the target image.

By transforming a coordinate system of a captured image, an image of which coordinate system is consistent with a coordinate system of an original target image is obtained. Then, style transfer is performed on the image to reduce the difference between obtained training data (i.e., the annotated raw image) and a raw image collected in the real environment.

In the embodiment of the present disclosure, by photographing the annotated target image, redirecting the annotated target image, and performing style transfer on the obtained image using the raw image collected in the real environment as supervision, the authenticity of the collected training data may be ensured to the greatest extent, the difference between the annotated raw image obtained and the raw image collected in the real environment may be reduced, data collection cost may be greatly reduced, and data support may be provided for a new perception network architecture that can be learned by the ISP. In addition, this solution can significantly reduce algorithm iteration time, avoid heavy annotation work, and quickly iterate algorithm versions.

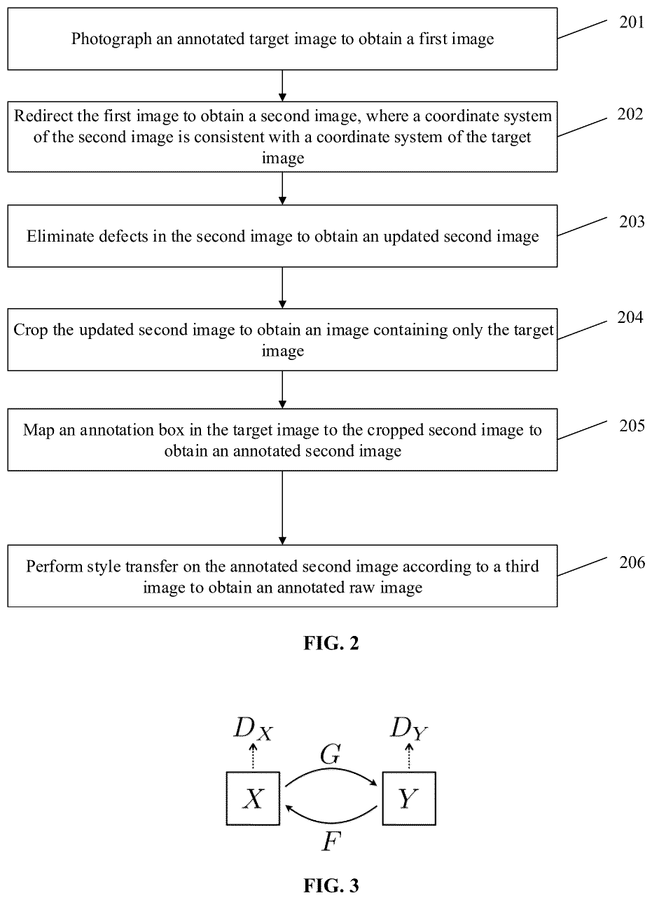

FIG. 2 is a flow diagram of another data acquisition method according to an embodiment of the present disclosure. As shown in FIG. 2, the method includes steps 201-206, which are specifically as follows.

In step 201, an annotated target image is photographed to obtain a first image.

The target image can be one or more, and this solution does not make any specific limitation on this.

The annotated target image may be, for example, an annotated RGB image. Specifically, an image displayed on a device such as a display screen may be photographed by a camera or the like, and an image captured by the camera is the first image.

In step 202, the first image is redirected to obtain a second image, where a coordinate system of the second image is consistent with a coordinate system of the target image.

Since the coordinate systems of the first image and the target image are not necessarily the same, the first image is redirected, so that its coordinate system is consistent with the coordinate system of the target image.

Specifically, a first coordinate system is established according to the target image and a preset checkerboard-marked image, and coordinates of corner points in the preset checkerboard-marked image in the first coordinate system are obtained.

The preset checkerboard-marked image is photographed, and coordinates of corner points in the preset checkerboard-marked image in a second coordinate system are obtained, where the second coordinate system is a coordinate system established according to the photographed image.

For example, when the target image is displayed on the display screen, the first coordinate system is established based on the preset checkerboard-marked image displayed on the display screen, and the coordinates of the corner points in the preset checkerboard-marked image in the first coordinate system are obtained. The preset checkerboard-marked image in the display screen is photographed, and the coordinates of the corner points in the preset checkerboard-marked image in the second coordinate system are obtained, where the second coordinate system is a coordinate system established according to the photographed image.

A transformation matrix between the second coordinate system and the first coordinate system is obtained according to the coordinates of the corner points in the preset checkerboard-marked image in the first coordinate system and the coordinates of the corner points in the preset checkerboard-marked image in the second coordinate system.

Affine transformation is performed on the first image according to the transformation matrix between the second coordinate system and the first coordinate system to obtain the second image.

In other words, redirection is achieved through coordinate transformation and other means.

The coordinates of the corner points in the first coordinate system are coordinates of corner points of a checkerboard in the real world. The coordinates of the corner points in the second coordinate system are pixel coordinates of the corner points of the checkerboard. By calculating a homography matrix (i.e., a transformation matrix) between the pixel coordinates and real coordinates and performing affine transformation on the captured image using this matrix, a viewing direction of a camera sensor may be adjusted so that the camera sensor faces the screen.

In step 203, defects in the second image are eliminated to obtain an updated second image.

Defects that may exist in the image include lens distortion, vignetting, noise, moiré and water ripples caused by a displayer, etc.

Specifically, Zhang's calibration method can be used for distortion correction, constrained minimization of log-intensity entropy can be used for vignetting correction, or spatial and temporal noise reduction and multi-band filtering can be used for noise reduction.

It should be noted that the defect elimination processing can specifically design corresponding enhancement units according to different defect needs brought about by different implementation scenarios, so as to achieve the effect of defect elimination.

When the defect level of an image is lower than a preset level, it is possible to directly perform style transfer processing or the like, without performing defect elimination on the image. For example, a small number of images taken in real scenes are defect-free, and generative adversarial networks (GAN) can compensate for defective images to a certain extent and generate defect-free data.

The above is only an example, and this solution does not make any specific limitation to this.

In step 204, the updated second image is cropped to obtain an image containing only the target image.

Since the picture captured by the camera may exceed the target image, the second image is cropped to cut off the area exceeding the target image, thereby obtaining an image containing only the target image.

In step 205, an annotation box in the target image is mapped to the cropped second image to obtain an annotated second image.

It can be understood that the annotation box is the annotation box in the annotated target image.

The annotated second image is obtained by mapping the annotation box in the target image to the cropped second image.

The cropped image has a corresponding size ratio relationship with the target image. The mapping may be determined based on the size ratio relationship, thereby obtaining the annotated second image.

In step 206, style transfer is performed on the annotated second image according to a third image to obtain an annotated raw image, where the third image is obtained by photographing a real environment corresponding to the target image.

By transforming a coordinate system of a captured image, an image of which coordinate system is consistent with a coordinate system of an original target image is obtained. Then, style transfer is performed on the image to reduce the difference between obtained training data (i.e., the annotated raw image) and a raw image collected in the real environment.

Affine transformation (or affine map) is a linear transformation from two-dimensional coordinates (x, y) to two-dimensional coordinates (u, v). In image processing, affine transformation can be applied to perform operations such as translation, scaling, and rotation on two-dimensional images.

Optionally, a generator and a discriminator are obtained according to the second image and the third image.

Style transfer is performed on the second image according to the generator and the discriminator to obtain an annotated raw image.

For example, GAN are used to take a small number of images collected from real scenes as a target style, and guide the captured image to transfer towards the target style in a generative network.

Specifically, as shown in FIG. 3, since there is an obvious style difference between raw data collected by photographing a screen (the second image, denoted as X) and raw data collected by photographing the real world (the target image, denoted as Y), the style of X is aligned to that of Y based on a Cycle GAN in this solution, thereby obtaining realistic annotated raw data. G and F are generators, DX and DY are discriminators. X generates Y′ based on the generator G, and continuously performs supervised learning based on the discriminator DY to obtain a trained generator G. Correspondingly, Y generates X′ based on the generator F, and continuously performs supervised learning based on the discriminator DX to obtain a trained generator F.

By using the GAN to take a small number of images collected in real scenes as the target style, the captured images are guided to transfer to the target style in the generative network, and realistic annotated raw images are obtained to reduce the difference between obtained raw images (training data) and raw images collected in the real environment (target images).

In the embodiment of the present disclosure, by photographing, redirecting, eliminating defects of and cropping the annotated target image, and performing style transfer on the obtained image using the raw image collected in the real environment as supervision, the authenticity of the collected training data may be ensured to the greatest extent, the difference between the annotated raw image obtained and the raw image collected in the real environment may be reduced, data collection cost may be greatly reduced, and data support may be provided for a new perception network architecture that can be learned by the ISP. In addition, this solution can significantly reduce algorithm iteration time, avoid heavy annotation work, and quickly iterate algorithm versions.

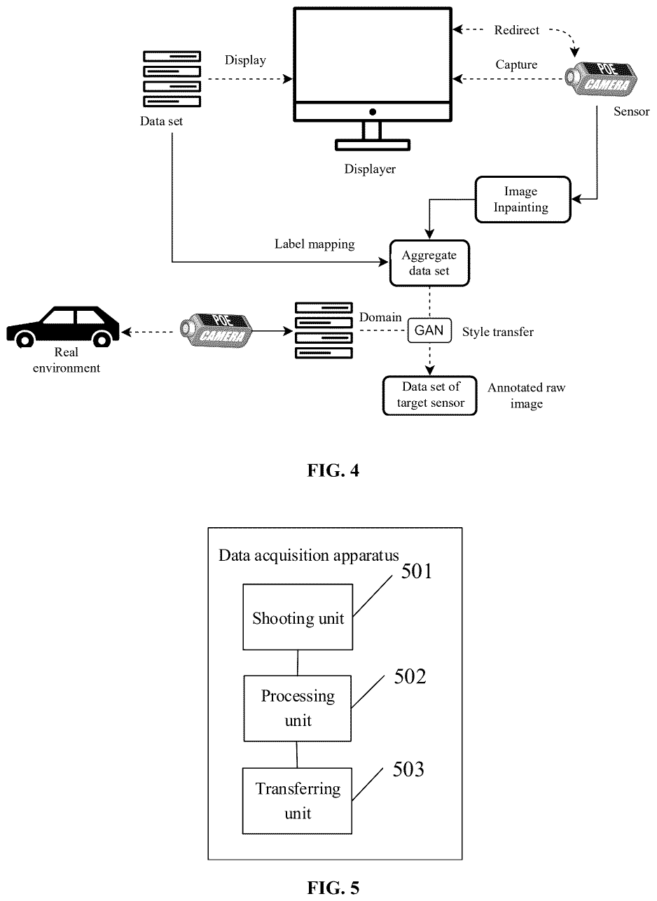

FIG. 4 is an application diagram of a data acquisition method according to an embodiment of the present disclosure. Data (images) in the dataset are displayed in a displayer. The camera sensor captures an image displayed on the displayer and redirects the captured image. Then, defect repair is performed on the redirected image and labels in the dataset are mapped to obtain an annotated processed image. In order to reduce the difference between the processed image and an image in the real environment, style transfer is performed based on the GAN to obtain an annotated raw image, which is training data.

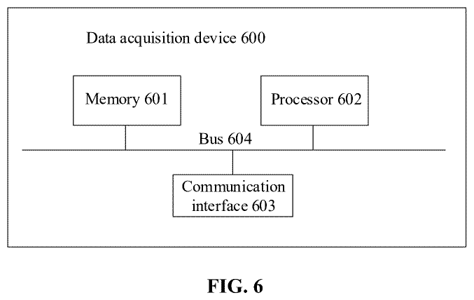

Based on the description of the data acquisition method in the above embodiment, an embodiment of the present disclosure provides a data acquisition apparatus. FIG. 5 is a structural diagram of a data acquisition apparatus according to an embodiment of the present disclosure. The data acquisition apparatus includes a shooting unit 501, a processing unit 502, and a transferring unit 503.

The shooting unit 501 is configured to photograph an annotated target image to obtain a first image.

The processing unit 502 is configured to redirect the first image to obtain a second image, where a coordinate system of the second image is consistent with a coordinate system of the target image.

The transferring unit 503 is configured to perform style transfer on the second image according to a third image to obtain an annotated raw image, where the third image is obtained by photographing a real environment corresponding to the target image.

The processing unit 502 is also configured to:
establish a first coordinate system according to the target image and a preset checkerboard-marked image, and obtain coordinates of corner points in the preset checkerboard-marked image in the first coordinate system;
photograph the preset checkerboard-marked image, and obtain coordinates of the corner points in the preset checkerboard-marked image in a second coordinate system, where the second coordinate system is a coordinate system established according to the photographed image;
obtain a transformation matrix between the second coordinate system and the first coordinate system according to the coordinates of the corner points in the preset checkerboard-marked image in the first coordinate system and the coordinates of the corner points in the preset checkerboard-marked image in the second coordinate system; and
perform affine transformation on the first image according to the transformation matrix between the second coordinate system and the first coordinate system to obtain the second image.

The transferring unit 503 is also configured to:
obtain a generator and a discriminator according to the second image and the third image; and
perform style transfer on the second image according to the generator and the discriminator to obtain the annotated raw image.

Optionally, the processing unit is also configured to eliminate defects in the second image to obtain an updated second image.

The transferring unit 503 is also configured to perform style transfer on the updated second image to obtain the annotated raw image.

The defects include at least one of followings:
lens distortion, vignetting, noise, moiré and/or water ripples caused by a displayer.

Further, the processing unit is also configured to:
crop the second image to obtain an image containing only the target image; and
map an annotation box in the target image to the cropped second image to obtain an annotated second image.

The transferring unit 503 is also configured to perform style transfer on the annotated second image to obtain the annotated raw image.

It is worth mentioning that specific functional implementations of the data acquisition apparatus can refer to the description of the data acquisition method, which will not be repeated here. The various units or modules in the data acquisition apparatus can be individually or completely combined into one or several other units or modules, or some of the units or modules can be further divided into multiple functionally smaller units or modules, which can achieve the same operation without affecting the realization of the technical effects of the embodiments of the present disclosure. The units or modules are divided based on logical functions. In practical applications, the function of one unit (or module) may also be implemented by multiple units (or modules), or the functions of multiple units (or modules) may be implemented by one unit (or module).

Based on the description of the method and apparatus in the above embodiments, an embodiment of the present disclosure provides a data acquisition device.

FIG. 6 is a structural diagram of a data acquisition device according to an embodiment of the present disclosure. A data acquisition device 600 shown in FIG. 6 (the device 600 may specifically be a computer device) includes a memory 601, a processor 602, a communication interface 603, and a bus 604. The memory 601, the processor 602, and the communication interface 603 are connected to each other through the bus 604.

The memory 601 may be a read-only memory (ROM), a static storage device, a dynamic storage device, or a random access memory (RAM).

The memory 601 can be stored with a program. When the program stored in the memory 601 is executed by the processor 602, the processor 602 and the communication interface 603 are configured to execute the various steps of the data acquisition method of the embodiment of the present disclosure.

The processor 602 can adopt a general-purpose central processing unit (CPU), a microprocessor, an application-specific integrated circuit (ASIC), a graphics processing unit (GPU) or one or more integrated circuits to execute relevant programs to implement the functions required to be performed by the units in the data acquisition apparatus of the embodiment of the present disclosure, or to execute the data acquisition method of the method embodiment of the present disclosure.

The processor 602 may also be an integrated circuit chip with signal processing capabilities. During implementation, each step of the data acquisition method of the present disclosure may be completed by an integrated logic circuit of hardware in the processor 602 or by instructions in software form. The processor 602 may also be a general-purpose processor, a digital signal processor (DSP), an application specific integrated circuit (ASIC), a field programmable gate array (FPGA) or other programmable logic devices, discrete gate or transistor logic devices, or discrete hardware components. The various methods, steps and logic diagrams disclosed in the embodiments of the present disclosure can be implemented or executed. The general-purpose processor may be a microprocessor, or any conventional processor, or the like. The steps of the method disclosed in the embodiments of the present disclosure can be directly implemented as being executed by a hardware decoding processor, or can be implemented by a combination of hardware and software units in the decoding processor. The software units may be located in a random access memory, a flash memory, a read-only memory, a programmable read-only memory, an electrically erasable programmable memory, a register, or other mature storage medium in the art. The storage medium is located in the memory 601, and the processor 602 reads information stored in the memory 601, and combines its hardware to complete the functions required to be performed by the units included in the data acquisition apparatus of the embodiment of the present disclosure, or execute the data acquisition method of the embodiment of the present disclosure.

The communication interface 603 uses a transceiver device such as but not limited to a transceiver to implement communication between the device 600 and other device or communication network. For example, data may be acquired through the communication interface 603.

The bus 604 may include a path for transmitting information between various components of the device 600 (e.g., the memory 601, the processor 602, and the communication interface 603).

It should be noted that although the device 600 shown in FIG. 6 only shows a memory, a processor, and a communication interface, during specific implementation, those skilled in the art should understand that the device 600 also includes other components necessary for normal operation. At the same time, according to specific needs, those skilled in the art should understand that the device 600 may also include hardware components for implementing other additional functions. In addition, those skilled in the art should understand that the device 600 may also include only the components necessary to implement the embodiments of the present disclosure, and does not necessarily include all the components shown in FIG. 6.

An embodiment of the present disclosure also provides a chip system, which is applied to an electronic device. The chip system includes one or more interface circuits and one or more processors, and the interface circuit and the processor are interconnected through lines. The interface circuit is configured to receive a signal from a memory of the electronic device and send the signal to the processor, where the signal includes a computer instruction stored in the memory. When the processor executes the computer instruction, the electronic device executes the data acquisition method.

An embodiment of the present disclosure also provides a computer-readable storage medium, which is stored with instructions. When the instructions are executed on a computer or a processor, the computer or the processor executes one or more steps in any of the above methods.

An embodiment of the present disclosure also provides a computer program product including instructions. When the computer program product runs on a computer or a processor, the computer or the processor executes one or more steps in any one of the above methods.

Those skilled in the art can clearly understand that, for the convenience and brevity of description, specific working processes of the system, apparatus, device and units described above can refer to specific descriptions of corresponding steps in the aforementioned method embodiments, and will not be repeated here.

It should be understood that in the description of this disclosure, unless otherwise specified, “/” indicates that the objects associated with each other are in an “or” relationship. For example, A/B can represent A or B, where A and B can be singular or plural. Also, in the description of the present disclosure, unless otherwise specified, “plurality/multiple” means two or more than two. “At least one of followings” or similar expressions refers to any combination of these items, including any combination of single or plural items. For example, at least one item among a, b, or c can be represented by: a, b, c, a-b, a-c, b-c, or a-b-c, where a, b, c can be single or plural.

In addition, in order to facilitate the clear description of the technical solutions of the embodiments of the present disclosure, in the embodiments of the present disclosure, words such as “first” and “second” are used to distinguish the same or similar items with basically the same functions and effects. Those skilled in the art can understand that the words “first”, “second”, or the like do not limit the quantity and execution order, and the words “first”, “second”, or the like do not necessarily limit the differences. At the same time, in the embodiments of the present disclosure, words such as “exemplary” or “for example” are used to indicate examples, illustrations, or descriptions. Any embodiment or design described as “exemplary” or “for example” in the embodiments of the present disclosure should not be construed as being preferred or advantageous over other embodiments or designs. To be precise, the use of words such as “exemplary” or “for example” is intended to present the relevant concepts in a concrete manner to facilitate understanding.

In the several embodiments provided in this disclosure, it should be understood that the disclosed system, apparatus, device and method may be implemented in other ways. For instance, the division of the units is only a logical function division. In a real implementation, there may be another manner for division. For instance, a plurality of units or components may be combined or may be integrated in another system, or some features can be ignored or not performed. The displayed or discussed mutual coupling or direct coupling or communication connection may be implemented through indirect coupling or communication connection of some interfaces, devices or units, and may be electrical, mechanical or in other forms.

The units described as separate components may or may not be physically separated. The components shown as units may or may not be physical units. In other words, the components may be located in one place, or may be distributed to a plurality of network units. According to certain needs, some or all of the units can be selected for realizing the purposes of the embodiments of the present disclosure.

The above embodiments may be implemented entirely or partly by means of software, hardware, firmware, or any combination thereof. When implemented using software, all or part of the implementation may be in the form of a computer program product. The computer program product includes one or more computer instructions. When a computer loads and executes the computer instructions, the computer may entirely or partly follow the steps or functions described in the examples of the present disclosure. The computer may be a general-purpose computer, a special purpose computer, a computer network, or other programmable device. The computer instructions may be stored in or transmitted via a computer-readable storage medium. The computer instructions can be transmitted from one website, computer, server or data center to another website, computer, server or data center by wired (e.g., coaxial cable, optical fiber, digital subscriber line (DSL)) or wireless (e.g., infrared, wireless, microwave, etc.) means. The computer-readable storage medium may be any available medium that can be accessed by a computer, or may be a data storage device such as a server or a data center that includes one or more available media. The available medium may be a read-only memory (ROM), or a random access memory (RAM), or a magnetic medium, such as a floppy disk, a hard disk, a tape, a disk, or an optical medium such as a digital versatile disc (DVD), or a semiconductor medium such as a solid state disk (SSD), etc.

The foregoing can be better understood according to the following articles:

Article A1. A data acquisition method, including:
photographing an annotated target image to obtain a first image;
redirecting the first image to obtain a second image, where a coordinate system of the second image is consistent with a coordinate system of the target image; and
performing style transfer on the second image according to a third image to obtain an annotated raw image, where the third image is obtained by photographing a real environment corresponding to the target image.

Article A2. The method of Article A1, where redirecting the first image to obtain the second image includes:
establishing a first coordinate system according to the target image and a preset checkerboard-marked image, and obtaining coordinates of corner points in the preset checkerboard-marked image in the first coordinate system;
photographing the preset checkerboard-marked image, and obtaining coordinates of the corner points in the preset checkerboard-marked image in a second coordinate system, where the second coordinate system is a coordinate system established according to the photographed image;
obtaining a transformation matrix between the second coordinate system and the first coordinate system according to the coordinates of the corner points in the preset checkerboard-marked image in the first coordinate system and the coordinates of the corner points in the preset checkerboard-marked image in the first coordinate system in the second coordinate system; and
performing affine transformation on the first image according to the transformation matrix between the second coordinate system and the first coordinate system to obtain the second image.

Article A3. The method of Article A1 or A2, where performing the style transfer on the second image according to the third image to obtain the annotated raw image, where the third image is obtained by photographing the real environment corresponding to the target image, includes:
obtaining a generator and a discriminator according to the second image and the third image; and
performing style transfer on the second image according to the generator and the discriminator to obtain the annotated raw image.

Article A4. The method of any one of Articles A1 to A3, further including:
eliminating defects in the second image to obtain an updated second image, where
performing the style transfer on the second image according to the third image to obtain the annotated raw image includes:
performing style transfer on the updated second image according to the third image to obtain the annotated raw image.

Article A5. The method of Article A4, where the defects include at least one of followings:
lens distortion, vignetting, noise, moiré and/or water ripples caused by a displayer.

Article A6. The method of any one of Articles A1 to A5, further including:
cropping the second image to obtain an image containing only the target image; and
mapping an annotation box in the target image to the cropped second image to obtain an annotated second image, where
performing the style transfer on the second image according to the third image to obtain the annotated raw image includes:
performing style transfer on the annotated second image according to the third image to obtain the annotated raw image.

Article A7. A data acquisition apparatus, including:
a shooting unit configured to photograph an annotated target image to obtain a first image;
a processing unit configured to redirect the first image to obtain a second image, where a coordinate system of the second image is consistent with a coordinate system of the target image; and
a transferring unit configured to perform style transfer on the second image according to a third image to obtain an annotated raw image, where the third image is obtained by photographing a real environment corresponding to the target image.

Article A8. The apparatus of Article A7, where the processing unit is configured to:
establish a first coordinate system according to the target image and a preset checkerboard-marked image, and obtain coordinates of corner points in the preset checkerboard-marked image in the first coordinate system;
photograph the preset checkerboard-marked image, and obtain coordinates of the corner points in the preset checkerboard-marked image in a second coordinate system, where the second coordinate system is a coordinate system established according to the photographed image;
obtain a transformation matrix between the second coordinate system and the first coordinate system according to the coordinates of the corner points in the preset checkerboard-marked image in the first coordinate system and the coordinates of the corner points in the preset checkerboard-marked image in the second coordinate system;
perform affine transformation on the first image according to the transformation matrix between the second coordinate system and the first coordinate system to obtain the second image.

Article A9. The apparatus of Article A7 or A8, where the transferring unit is configured to:
obtain a generator and a discriminator according to the second image and the third image; and
perform style transfer on the second image according to the generator and the discriminator to obtain the annotated raw image.

Article A10. The apparatus of any one of Articles A7 to A9, where the processing unit is also configured to:
eliminate defects in the second image to obtain an updated second image, and where
the transferring unit is also configured to:
perform style transfer on the updated second image according to the third image to obtain the annotated raw image.

Article A11. The apparatus of Article A10, where the defects include at least one of followings:
lens distortion, vignetting, noise, moiré and/or water ripples caused by a displayer.

Article A12. The apparatus of any one of Articles A7 to A11, where the processing unit is also configured to:
crop the second image to obtain an image containing only the target image; and
map an annotation box in the target image to the cropped second image to obtain an annotated second image, where
the transferring unit is also configured to:
perform style transfer on the annotated second image according to the third image to obtain the annotated raw image.

Article A13. A data acquisition device, including a processor and a memory, where
the processor is connected with the memory, where the memory is configured to store program codes, and the processor is configured to call the program codes to execute the data acquisition method of any one of Articles Al to A6.

Article A14. A computer-readable storage medium, on which a computer program is stored, where the computer program includes a program instruction, and when the program instruction is executed by a processor, the data acquisition method of any one of Articles A1 to A6 is implemented.

Article A15. A computer program product, including a computer program, which, when executed by a processor, implements the data acquisition method of any one of Articles A1 to A6.

Article A16. A chip system, applied to an electronic device, where the chip system includes one or more interface circuits and one or more processors; the interface circuit and the processor are interconnected through lines; the interface circuit is configured to receive a signal from a memory of the electronic device and send the signal to the processor, where the signal includes a computer instruction stored in the memory; and when the processor executes the computer instruction, the electronic device executes the data acquisition method of any one of Articles A1 to A6.

The above is only specific implementation of the embodiments of the present disclosure, but the protection scope of the embodiments of the present disclosure is not limited to this. Any changes or substitutions within the technical scope disclosed in the embodiments of the present disclosure should be covered within the protection scope of the embodiments of the present disclosure. Therefore, the protection scope of the embodiments of the present disclosure shall be based on the protection scope of the claims.

What is claimed:

1. A data acquisition method, comprising:
photographing an annotated target image to obtain a first image;
redirecting the first image to obtain a second image, wherein a coordinate system of the second image is consistent with a coordinate system of the target image; and
performing style transfer on the second image according to a third image to obtain an annotated raw image, wherein the third image is obtained by photographing a real environment corresponding to the target image.

2. The method of claim 1, wherein redirecting the first image to obtain the second image comprises:
establishing a first coordinate system according to the target image and a preset checkerboard-marked image, and obtaining coordinates of corner points in the preset checkerboard-marked image in the first coordinate system;
photographing the preset checkerboard-marked image, and obtaining coordinates of the corner points in the preset checkerboard-marked image in a second coordinate system, wherein the second coordinate system is a coordinate system established according to the photographed image;
obtaining a transformation matrix between the second coordinate system and the first coordinate system according to the coordinates of the corner points in the preset checkerboard-marked image in the first coordinate system and the coordinates of the corner points in the preset checkerboard-marked image in the second coordinate system; and
performing affine transformation on the first image according to the transformation matrix between the second coordinate system and the first coordinate system to obtain the second image.

3. The method of claim 1, wherein performing the style transfer on the second image according to the third image to obtain the annotated raw image, wherein the third image is obtained by photographing the real environment corresponding to the target image, comprises:
obtaining a generator and a discriminator according to the second image and the third image; and
performing style transfer on the second image according to the generator and the discriminator to obtain the annotated raw image.

4. The method of claim 1, further comprising:
eliminating defects in the second image to obtain an updated second image, wherein
performing the style transfer on the second image according to the third image to obtain the annotated raw image comprises:
performing style transfer on the updated second image according to the third image to obtain the annotated raw image.

5. The method of claim 4, wherein the defects comprise at least one of followings:
lens distortion, vignetting, noise, moiré and/or water ripples caused by a displayer.

6. The method of claim 1, further comprising:
cropping the second image to obtain an image containing only the target image; and
mapping an annotation box in the target image to the cropped second image to obtain an annotated second image, wherein
performing the style transfer on the second image according to the third image to obtain the annotated raw image comprises:
performing style transfer on the annotated second image according to the third image to obtain the annotated raw image.

7. A data acquisition apparatus, comprising:
a shooting unit configured to photograph an annotated target image to obtain a first image;
a processing unit configured to redirect the first image to obtain a second image, wherein a coordinate system of the second image is consistent with a coordinate system of the target image; and
a transferring unit configured to perform style transfer on the second image according to a third image to obtain an annotated raw image, wherein the third image is obtained by photographing a real environment corresponding to the target image.

8. The apparatus of claim 7, wherein the processing unit is configured to:
establish a first coordinate system according to the target image and a preset checkerboard-marked image, and obtain coordinates of corner points in the preset checkerboard-marked image in the first coordinate system;
photograph the preset checkerboard-marked image, and obtain coordinates of the corner points in the preset checkerboard-marked image in a second coordinate system, wherein the second coordinate system is a coordinate system established according to the photographed image;
obtain a transformation matrix between the second coordinate system and the first coordinate system according to the coordinates of the corner points in the preset checkerboard-marked image in the first coordinate system and the coordinates of the corner points in the preset checkerboard-marked image in the second coordinate system; and
perform affine transformation on the first image according to the transformation matrix between the second coordinate system and the first coordinate system to obtain the second image.

9. The apparatus of claim 7, wherein the transferring unit is configured to:
obtain a generator and a discriminator according to the second image and the third image; and
perform style transfer on the second image according to the generator and the discriminator to obtain the annotated raw image.

10. The apparatus of claim 7, wherein the processing unit is also configured to:
eliminate defects in the second image to obtain an updated second image, wherein
the transferring unit is also configured to:
perform style transfer on the updated second image according to the third image to obtain the annotated raw image.

11. The apparatus of claim 10, wherein the defects comprise at least one of followings:
lens distortion, vignetting, noise, moiré and/or water ripples caused by a displayer.

12. The apparatus of claim 7, wherein the processing unit is also configured to:
crop the second image to obtain an image containing only the target image; and
map an annotation box in the target image to the cropped second image to obtain an annotated second image, wherein
the transferring unit is also configured to:
perform style transfer on the annotated second image according to the third image to obtain the annotated raw image.

13. A data acquisition device, comprising a processor and a memory, wherein
the processor is connected with the memory, wherein the memory is configured to store program codes, and the processor is configured to call the program codes to execute the data acquisition method of claim 1.

14. A computer-readable storage medium, on which a computer program is stored, wherein the computer program comprises a program instruction, and when the program instruction is executed by a processor, the data acquisition method of claim 1 is implemented.

15. A computer program product, comprising a computer program, which, when executed by a processor, implements the data acquisition method of claim 1.

16. A chip system, applied to an electronic device, wherein the chip system comprises one or more interface circuits and one or more processors; the interface circuit and the processor are interconnected through lines; the interface circuit is configured to receive a signal from a memory of the electronic device and send the signal to the processor, wherein the signal comprises a computer instruction stored in the memory; and
when the processor executes the computer instruction, the electronic device executes the data acquisition method of claim 1.

17. The method of claim 2, wherein performing the style transfer on the second image according to the third image to obtain the annotated raw image, wherein the third image is obtained by photographing the real environment corresponding to the target image, comprises:
obtaining a generator and a discriminator according to the second image and the third image; and
performing style transfer on the second image according to the generator and the discriminator to obtain the annotated raw image.

18. The method of claim 2, further comprising:
eliminating defects in the second image to obtain an updated second image, wherein
performing the style transfer on the second image according to the third image to obtain the annotated raw image comprises:
performing style transfer on the updated second image according to the third image to obtain the annotated raw image.

19. The method of claim 3, further comprising:
eliminating defects in the second image to obtain an updated second image, wherein
performing the style transfer on the second image according to the third image to obtain the annotated raw image comprises:
performing style transfer on the updated second image according to the third image to obtain the annotated raw image.

20. The method of claim 2, further comprising:
cropping the second image to obtain an image containing only the target image; and
mapping an annotation box in the target image to the cropped second image to obtain an annotated second image, wherein
performing the style transfer on the second image according to the third image to obtain the annotated raw image comprises:
performing style transfer on the annotated second image according to the third image to obtain the annotated raw image.
